(19) United States
(12) Patent Application Publication
(10) Pub. No.: US 2004/0136457 A1
(43) Pub. Date: Jul. 15, 2004

(54) Method and system for supercompression of compressed digital video

(76) Inventors: John Funnell, Southampton (GB); Yevgeniy A. Kuznetsov, San Diego, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/693,680

(22) Filed: Oct. 23, 2003

Related U.S. Application Data
(60) Provisional application No. 60/420,700, filed on Oct. 23, 2002.
(60) Provisional application No. 60/420,504, filed on Oct. 23, 2002.

(51) Int. Cl. H04N 7/12

(52) U.S. Cl. 375/240.01; 375/240.23

(57) ABSTRACT

A converter receives a compressed video stream conformant to one format and re-encodes selected syntactic elements using superior entropy compression algorithms to produce a smaller stream conformant to a second standard. The converter passes through other compressed syntactic elements without re-encoding them to expedite processing, while still producing a smaller stream conformant to the second standard. In variations, a dual output encoder receives an uncompressed video stream and generates a first compressed stream conformant to one formant and a second stream conformant to a second standard. A second converter may be used to convert back to the original format with little or no loss. In some variations, novel arithmetic coding techniques are utilized to recompress previously compressed data.

This application claims priority under 35 U.S.C. § 119(e) to U.S. Provisional Patent Application Serial No. 60/420,700 filed Oct. 23, 2002 entitled: METHOD AND SYSTEM FOR SUPERCOMPRESSION OF COMPRESSED DIGITAL VIDEO, which is incorporated herein by reference. This application also claims priority under 35 U.S.C. § 119(e) to U.S. Provisional Patent Application Serial No. 60/420,504 filed Oct. 23, 2002, entitled METHOD AND SYSTEM FOR USING ARITHMETIC CODING IN SUPERCOMPRESSION OF COMPRESSED DIGITAL VIDEO which is incorporated herein by reference.

### FIELD OF THE INVENTION

The present invention relates generally to digital data transmission, and more specifically to digital data compression. Even more specifically, the present invention relates to accommodation of multiple digital data compression formats.

### BACKGROUND OF THE INVENTION

As is known, a pixel is a dot of light displayed on a video display device with a certain color. The term “frame” has been employed to refer to a matrix of pixels at a given resolution. For example, a frame may comprise a 640 by 480 rectangle of pixels containing 480 rows having 640 pixels each. In an uncompressed state, the amount of data required to represent a frame is equal to the number of pixels times the number of bits associated with each pixel to represent color. Thus, in a pure black and white image lacking any grayscale shades, a pixel could be represented by one bit where “1” represents white and “0” represents black. More typically, in modern full-color displays a single pixel is represented by 8-bits, 16-bits or 32-bits.

Thus, a single uncompressed 32-bit frame at a resolution of 640 by 480 would require (32*640*480) 9.8 million bits, or 1.2 Megabytes of data.

Digital video is the display of a series of frames in sequence (e.g., a motion picture is composed of 24 frames displayed every second). Thus, one second of uncompressed 32 bit frames at a resolution of 640 by 480 requires (1.2*24) 29.5 Megabytes of data.

Digital video compression is a complex process that may use any of a variety of techniques to transform (“encode”) a unit of uncompressed video data into a unit of data that requires fewer bits to represent the content of the original uncompressed video data. The resultant encoded data is capable of being transformed using a reverse process (“decode”) that provides a digital video unit of data that is either identical to the original data (“lossless compression”) or visually similar to the original data to a greater or lesser degree (“lossy compression”).

Modern techniques of digital video compression can achieve very high levels of compression with relatively low loss of visual quality. As a general rule, modern techniques of digital video compression are very computationally intensive and the degree of compression varies directly with the amount of computationally intensity. Anything that adds to computational intensity over and above the decoding techniques is undesirable. In particular, in virtually all forms of modern compression the amount of data in each compressed video frame will vary, sometimes to a great extent. This maximizes compression, but at the cost of making the processing power needed to decode the frames inconsistent.

Typical digital video encoders have been used to reduce the size of a stream of uncompressed digital video data. FIG. 1 is a block diagram of a conventional digital video encoder 125, which is comprised of a video processing unit 110 and an entropy compression unit 115. Digital video encoder 125 uses motion estimation and motion compensation to exploit temporal redundancy in some of the uncompressed video frames 120 that comprise its input signal in order to generate compressed video output.

During operation of video encoder 125, video processing unit 110 accepts uncompressed video frames 120 and applies one or more video and signal processing techniques to such frames. These techniques may include, for example, motion compensation, filtering, two-dimensional (“2D”) transformation, block mode decisions, motion estimation, and quantization. The associated event matrices include some or all of: a skipped blocks binary matrix, a motion compensation mode (e.g. intra/forward/bi-directional) matrix, a motion compensation block size and mode matrix (e.g. 16×16 or 8×8 or interlaced), a motion vectors matrix, and a matrix of transformed and quantized block coefficients.

In the special case of a lossy video encoder, these techniques aim to retain image information that is important to the human eye. The video processing unit 110 produces data streams 124 that are more suitable than the uncompressed video frames 120 as an input to entropy coding algorithms. Conventionally, these intermediate data streams 124_{a-c} would comprise transform coefficients with clear statistical redundancies and motion vectors. As an example, video processing unit 110 can apply a block DCT or other transform function to the output of motion compensation and quantize the resulting coefficients.

An entropy coding technique such as Huffman Coding can then be applied by entropy compression unit 115 to the data streams 124_{a-c} in order to produce a compressed stream 130. The entropy compression unit 115 compresses the data streams with no loss of information by exploiting their statistical redundancies. The compressed stream 130 output by entropy compression unit 115 is of significantly smaller size than both the uncompressed video frames 120 and the intermediate data stream 124 information.

Similarly, as shown in FIG. 2, a conventional digital video decoder 230 may be divided into two logical components: entropy decompression unit 235 and video processing unit 240. Entropy decompression unit 235 receives the compressed data stream 103 and outputs data streams 250_{a-c} typically comprising motion vectors and transform (or quantized) coefficients. Video processing unit 240 takes the data stream output 250_{a-c} from decompression unit 235 and performs operations such as motion compensation, inverse quantization, and inverse 2-D transformation in order to reconstruct the uncompressed video frames.

MPEG (Motion Pictures Experts Group) and the ISO (International Standards Organization) have produced international standards specifying such video compression and decompression algorithms of the type implemented by the encoder 125 and decoder 230, respectively. These standards include MPEG-1, MPEG-2, MPEG-4, H.261, H.263, and permit equipment, hardware, and software from different manufacturers to exchange compressed video with ease in accordance with the applicable algorithm. The MPEG-4 video compression technique is very efficient, and is generally considered to produce virtually “incompressible” output.

Since standardization of these algorithms, research has revealed motion compensation, transform, and entropy coding techniques that can compress video with equivalent subjective quality as the older techniques while producing significantly less compressed data. Work is currently underway at MPEG and ISO to produce a new standard “H.26L” that will incorporate some of the newer algorithms.

There are a number of problems that arise when a superior video compression technology or standard becomes available:

legacy encoders will not be able to compress video according to the new standards;

legacy decoders will not be able to decompress video according to the new standards;

legacy compressed video content stored on disk or tape needs to be recompressed according to the new standard in order to take advantage of the newer techniques; and

video that is recompressed will have been subject to two lossy processes and will thus be of an inferior quality.

What is needed, then, is a method and system for compressing and decompressing video using new standards as they become available, without subjecting the video to two lossy processes.

### SUMMARY OF THE INVENTION

In one embodiment, the invention can be characterized as a method, and a processor readable medium containing processor executable instructions for carrying out the method, for converting digital video from a first compressed format to a second compressed format, the method comprising: receiving an input digital video stream in said first compressed format; demultiplexing said input digital video stream so as to generate a multiplicity of constituent data streams, wherein said constituent data streams include a compressed data stream; decompressing said compressed data stream so as to generate a decompressed data stream; compressing said decompressed data stream so as to generate a recompressed data stream, wherein said recompressed data stream is more compressed than said compressed data stream and wherein said recompressed data stream conveys identical semantic information as said compressed data stream; and multiplexing said recompressed data stream and a subset of said constituent data streams that was not subject to said decompressing into an output digital video stream in said second compressed format.

In another embodiment, the invention can be characterized as a method, and a processor readable medium containing processor executable instructions for carrying out the method, for converting digital video from a first compressed format to a second compressed format, the method comprising: receiving an input digital video stream in said first compressed format; demultiplexing said input digital video stream so as to generate a multiplicity of constituent data streams, wherein said constituent data streams include a compressed data stream; decompressing said compressed data stream so as to generate a decompressed data stream; compressing said decompressed data stream so as to generate a recompressed data stream, wherein said recompressed data stream conveys identical semantic information as said compressed data stream; and multiplexing said recompressed data stream with a subset of said constituent data streams that was not subject to said decompressing into an output digital video stream in said second compressed format.

In a further embodiment, the invention may be characterized as a method, and a processor readable medium containing processor executable instructions for carrying out the method, for transforming uncompressed video frames into at least two compressed formats, the method comprising: receiving uncompressed video frames; processing said uncompressed video frames into intermediate data streams; applying a first entropy compression format to at least some of said intermediate data streams so as to generate a first set of compressed data streams; applying a second entropy compression format to at least some of said intermediate data streams so as to generate a second set of compressed data streams; multiplexing at least said first set of compressed data streams so as to generate a video stream in accordance with said first format; and multiplexing at least said second set of compressed data streams so as to generate a video stream in accordance with said second format.

In yet another embodiment, the invention may be characterized as a method for converting digital video from a first compressed format to a second compressed format, the method comprising: receiving an input digital video stream in said first compressed format; demultiplexing said input digital video stream so as to generate one or more compressed data streams and an uncompressed data stream; decompressing one of said one or more compressed data streams so as to generate a decompressed data stream; compressing said decompressed data stream so as to generate a recompressed data stream; compressing said uncompressed data stream so as to generate a newly compressed data stream; and multiplexing said recompressed data stream and said newly compressed data stream into an output digital video stream in said second compressed format.

In yet another embodiment, the invention may be characterized as a method for converting digital video from a first compressed format to a second compressed format, the method comprising: receiving an input digital video stream in said first compressed format; demultiplexing said input digital video stream so as to generate a plurality of compressed data streams; decompressing one of said plurality of compressed data streams so as to generate a decompressed data stream; compressing said decompressed data stream so as to generate a recompressed data stream, wherein said recompressed data stream is more compressed than said one of said plurality of compressed data streams; and multiplexing said recompressed data stream with another of said plurality of compressed data streams into an output digital video stream in said second compressed format.

### BRIEF DESCRIPTION OF THE DRAWINGS

FIG. 1 is a block diagram depicting a conventional digital video encoder according to the prior art;

FIG. 2 is a block diagram depicting a conventional digital video decoder according to the prior art;

FIG. 3 is a block diagram depicting a compressing converter according to an embodiment of the present invention;

FIG. 4 is a block diagram depicting one embodiment of the compressing converter of FIG. 3;

FIG. 5 is a flow chart depicting steps carried out by the compressing converter of FIG. 4 according to one embodiment;

FIG. 6 is a block diagram depicting a dual output digital video encoder according to an embodiment of the present invention;

FIG. 7 is a block diagram depicting a dual output digital video encoder according to another embodiment of the present invention;

FIG. 8 is a block diagram depicting a dual output digital video encoder according to yet another embodiment of the present invention;

FIG. 9 is a block diagram depicting one embodiment of the video processors of FIGS. 6, 7 and 8;

FIG. 10 is a block diagram depicting a dual input digital video decoder according to an embodiment of the present invention;

FIG. 11 depicts four different bitmaps for determining a context value according to an exemplary embodiment;

FIG. 12 is a flow chart showing steps carried out during supercompression of digital video event matrices using arithmetic coding;

FIG. 13 is a flow chart showing steps carried out during decompression of supercompressed digital video event matrices using arithmetic coding;

FIG. 14 depicts an exemplary event matrix to be supercompressed; and

FIG. 15 depicts a partially populated event matrix to be further decompressed.

### DETAILED DESCRIPTION

As is described herein, the present invention relates to a system and method for further compression of compressed video content, which is also referred herein as supercompression of compressed video content. In accordance with one aspect of the invention, a compressing converter receives a digital video signal in a first compressed format, i.e., format A. The compressing converter re-encodes some or all of the elements of the compressed stream using different entropy coding techniques than those used to generate the original stream. This re-encoding may be done in such a way that none of the signal information pertaining to the video in the original stream is lost or modified. The re-encoding generates an output digital video signal compliant with a second format, i.e., format B.

The output digital video signal may then be processed by a decompressing converter. In operation, the decompressing converter receives a digital video signal in the format B and generates an output digital video signal that complies with format A. In an exemplary embodiment, format B is designed or chosen so that it uses identical video processing steps as format A but may be entropy-encoded to a higher compression than format A. Thus the process of converting from format A to format B results in a compressed bitstream that is significantly smaller.

Advantageously, the invention according to several embodiments allows users of a legacy video format to take advantage of new entropy compression techniques whilst retaining compliance with their existing encoders, decoders and compressed content.

The teachings of the invention may also be utilized within a dual output encoder and a dual input decoder. As is described below, these devices may be used in applications where an encoder or decoder together with a compression or decompression converter would otherwise be needed.

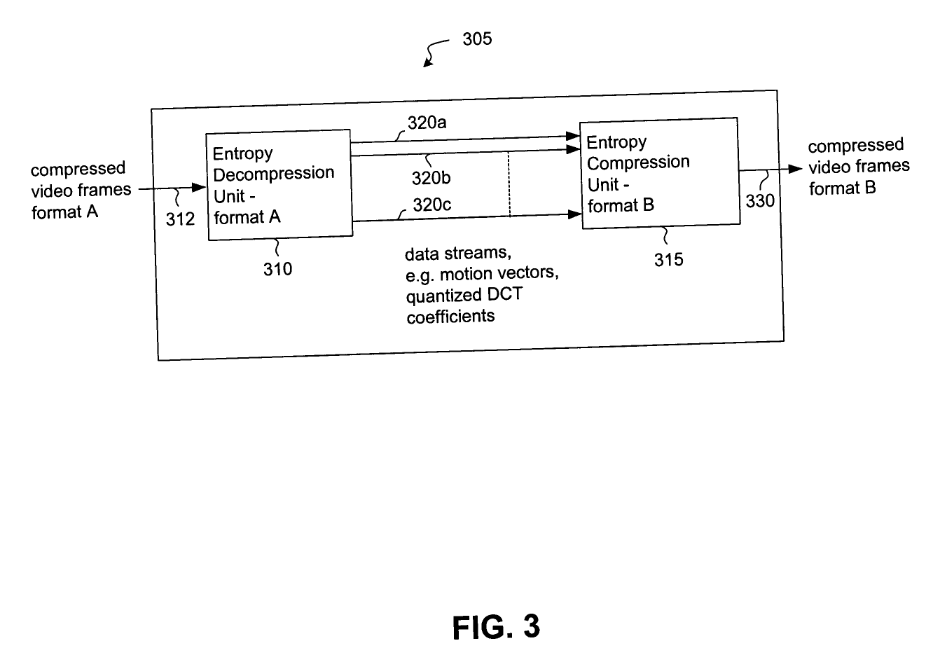

Turning now to FIG. 3, a compressing converter 305 according to one embodiment of the present invention transforms one type of digital video data stream to a different, compressed representation of the exact same information. As shown in FIG. 3, compressing converter 305 includes an entropy decompression unit 310 configured to process compressed video frames 312 of video compression format A. The compressing converter 305 further includes an entropy compression unit 315 designed to compress intermediate data streams 320_{a-c} produced by decompression unit 310 into compressed video frames 330 of video compression format B.

As discussed herein, the compressed video frames 312 of video compression format A include a multiplicity constituent data streams, which the entropy decompression unit 310 processes to provide the multiplicity of intermediate streams 320_{a-c}. In an exemplary embodiment, entropy decompression unit 310 decompresses some of the compressed format A constituent data streams while passing through other compressed format A constituent data streams so as to generate intermediate data streams 320_{a-c} comprising both uncompressed data streams and data streams compressed according to format A entropy compression techniques. The entropy compression unit 315 then recompresses one or more of the uncompressed data streams using entropy compression algorithms of format B so as to generate recompressed data streams. The recompressed data streams are then multiplexed with the compressed data streams so as to generate the compressed video frames 330 of video compression format B.

In other embodiments, the entropy compression unit 310 may decompress all of the constituent streams of the format A compressed stream 312 so that all of the decompressed data streams may be recompressed with entropy compression techniques that provide greater compression with respect to format A compression techniques. One of ordinary skill in the art will appreciate that there may be a tradeoff between the amount of increased compression gained by decompressing and recompressing (according to format B) all of the constituent data streams of the format A compressed stream 312 and the added time necessary to decompress and recompress all of the constituent data streams. As a consequence, some of the format A constituent data streams may be passed through the format A entropy decompression unit 310 and the format B entropy compression unit 330 without being decompressed and recompressed, if decompressing and recompressing them does not provide an amount of compression gain commensurate with the time associated with the recompression process.

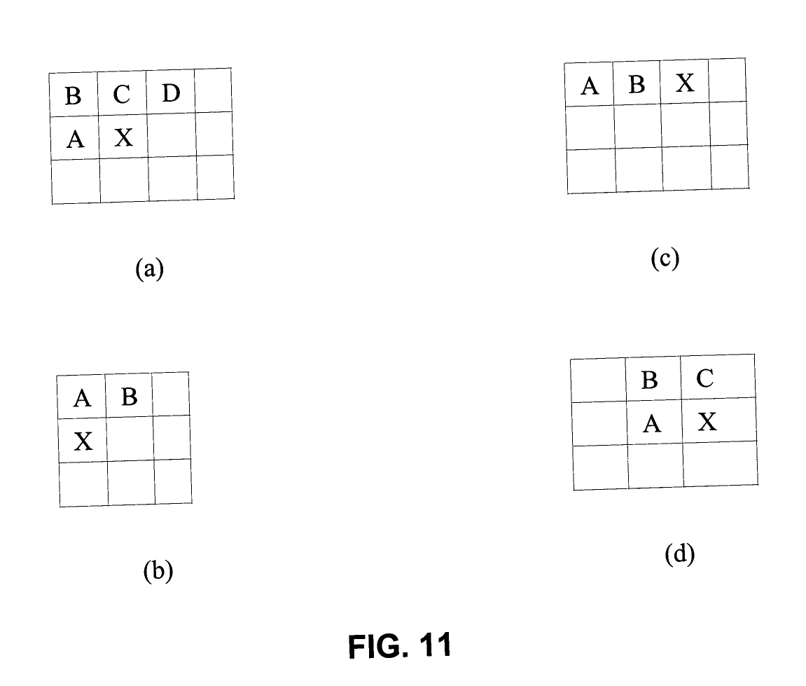

In an exemplary embodiment, the entropy compression algorithm of format B is a lossless, yet more highly compressive algorithm than the format A algorithm so that the resulting compressed video frames 330 of video compression format B provides a more compressed representation of the exact same information as is contained in the format A compressed video frames 312. One exemplary compression algorithm, which may be implemented as the format B compression algorithm, is described herein with reference to FIGS. 11-15. It should be recognized, however, that other compression techniques may be used to supercompress compressed video content without departing from the scope of the present invention.

In an exemplary embodiment, the format A compressed stream 312 is formatted in accordance with the ISO MPEG-4 video standard, which makes extensive use of Huffman coding. In this embodiment the format B compression scheme uses arithmetic coding for syntactic elements: block coded/not coded patterns, block coding intra/inter modes, motion compensation block mode selection, block sizes, and DCT or other transform coefficients, for a subset of the video frames. Format B in this embodiment may share the original MPEG-4 entropy coding for the remaining data steam elements. This embodiment is also suitable for other DCT-based compressed video formats.

In another embodiment, the format A compressed stream 312 is in accordance with the H.264 Context-based Adaptive Variable Length Coding (CAVLC) standard and the format B compressed video stream 330 is in accordance with the H.264 Context Adaptive Binary Arithmetic Coding (CABAC).

As one of ordinary skill in the art will appreciate, the compressing converter 305 may be adapted so that it receives an arithmetically coded format B video stream and generates a format A output stream in accordance with ISO MPEG-4.

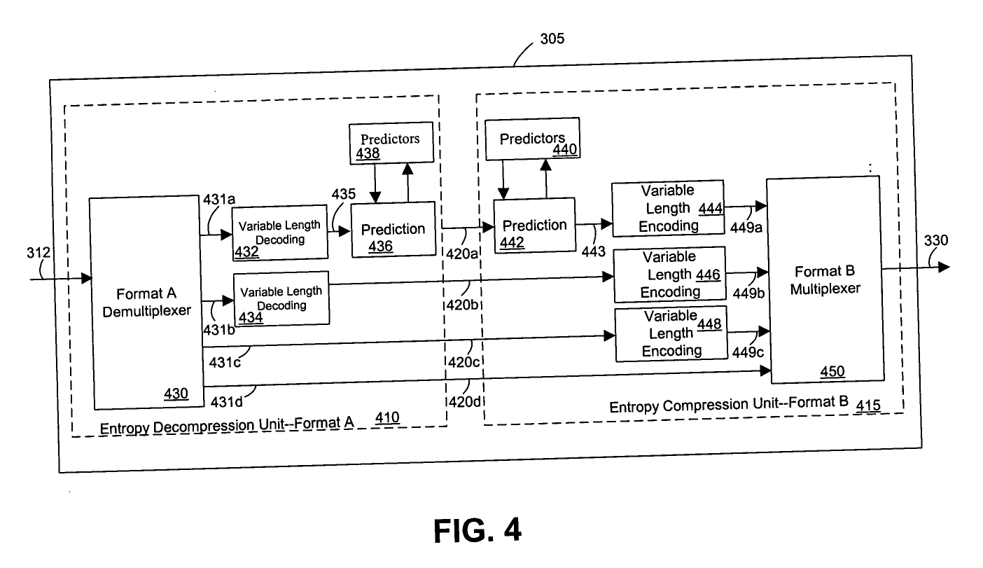

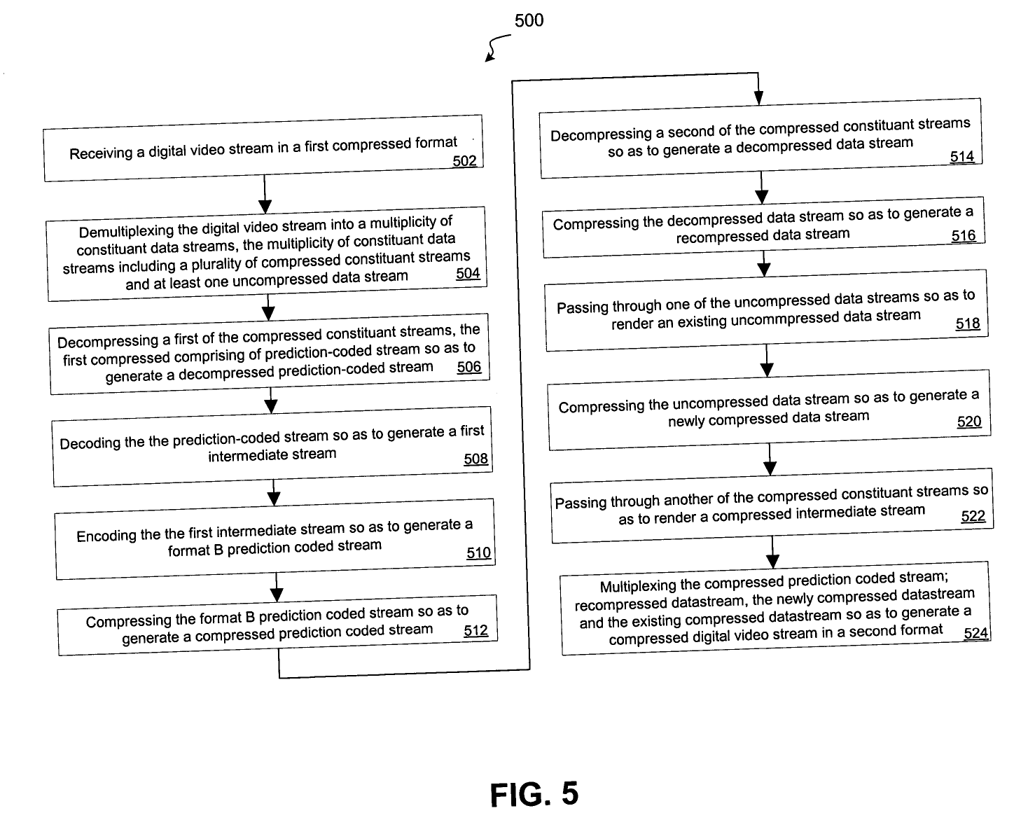

Referring next to FIG. 4, shown is a block diagram of one embodiment of the compressing converter of FIG. 3. As shown, the compressing converter 305 includes an entropy decompression unit 410 coupled with an entropy compression unit 415. As shown, the entropy decompression unit 410 and the entropy compression unit 415 are specific embodiments of the entropy decompression unit 310 and the entropy compression unit 315 described with reference to FIG. 3. The entropy decompression unit 410 is configured to receive the format A compressed video data stream 312 and generate intermediate data streams 420_{a-d}, which are provided to an entropy compression unit 415. The entropy compression unit 415 then generates the format B compressed digital video data stream 330 from the intermediate data streams 420_{a-d}. While referring to FIG. 4 simultaneous reference will be made to FIG. 5, which is a flow chart depicting steps of an exemplary embodiment, which are carried out by the compression converter 305 when converting a compressed video data stream of format A to a compressed video data stream of format B.

As shown in FIG. 4, the compressed video data stream 312 of video compression format A is initially received by a format A demultiplexer within the entropy decompression unit 410 (Step 502). The format A demultiplexer then demultiplexes the compressed video data stream 312 into its constituent data streams 431_{a-d} (Step 504). In the present embodiment, the constituent data streams include a plurality of compressed constituent streams 431ₐ, 431_{b} and 431_{d} and at least one uncompressed data stream 431_{c}. It should be recognized that each of the constituent streams 431_{a-d} illustrated in FIG. 4 represent a different processing path that may be taken by constituent streams of the format A compressed signal 312. Moreover, each constituent stream 431_{a-d} may include one, two or multiple syntactic data elements of the format A compressed signal 305.

For example, in embodiments where format A is MPEG-4 video according to ISO/IEC 14496-2 specification, a first constituent data stream 431ₐ may include “motion vector” and “block” planes; a second constituent data stream 431_{b} may, but not necessarily must, include “mcbpc,” “cbpy” and “block” planes; a third constituent stream 431_{c} includes “acpred,” “mcsel” and “not coded” planes; and a forth-constituent stream 431_{d}, which is neither decompressed or recompressed, may include any of the above-mentioned planes depending upon whether it is advantageous to send a particular stream through the compression converter 305 without either decompressing or compressing the stream.

As shown, the first of the compressed constituent streams 431ₐ is a prediction-coded stream (e.g., a motion vector stream), which is decompressed by a first decoding module 432 to produce a decompressed prediction-coded stream 435 (Step 506). The decompressed prediction-coded stream 435 is then provided to the data prediction module 436, which in cooperation with the stored predictors 438, decodes the prediction-coded stream 435 so as to generate a first intermediate stream 420ₐ (Step 508). The first intermediate stream 420ₐ is then received by a prediction encoding module 442, which in cooperation with stored predictors 440, prediction encodes the first intermediate stream 420ₐ according to format B to produce an encoded stream 443 (Step 510). The encoded stream 443 is received by a first variable length encoding module 444, which compresses the encoded stream according to format B entropy compression techniques so as to generate a compressed prediction coded stream 449ₐ (Step 512).

As shown in FIG. 4, a second constituent data stream 431_{b} is decompressed by a second decoding module 434 to produce a second intermediate data stream 420_{b} (Step 514). The second intermediate data stream 420_{b} is then received and compressed by a second variable length encoding module 446 according to format B entropy compression techniques so as to generate a recompressed data stream 449_{b} (Step 516).

As shown, uncompressed constituent stream 431 is passed through the entropy compression unit 410 to the entropy compression unit 415 as an uncompressed intermediate stream 402, (Step 518). This stream is a stream of data that is not compressed according to format A, but is passed along to the entropy compression unit 415 where it is compressed according to format B entropy compression techniques so as to generate a newly compressed data stream 449_{c} (Step 520).

As shown in FIG. 4, another compressed constituent stream 431_{d} is passed through the entropy decompression unit 410 as a compressed intermediate stream 420_{d}, which is received by the format B multiplexer 450 (Step 522). The format B multiplexer, as depicted in FIG. 4, receives and multiplexes the compressed prediction stream 449ₐ, the recompressed data stream 449_{b}, the newly compressed data stream 449_{c} and the compressed intermediate stream 420_{d} into the compressed digital video data stream 330 of format B (Step 524).

Advantageously, in the embodiment described with reference to FIG. 4, the compression converter 305 is configured to implement format B compression techniques that utilize the same or different prediction encoding/decoding as format A. Specifically, the prediction decoder 436 may be configured to remove the prediction encoding regardless of its format to provide an intermediate stream 420ₐ that is encoded by the prediction encoder 442 according to format B.

It should be recognized, however, that in some embodiments, the format B compression uses the same prediction coding as format A. In these embodiments, the prediction decoder 436 and the prediction encoder 442 are unnecessary and need not be incorporated into the compression converter 305. Likewise, Steps 508 and 510 need not be carried out, and the decompressed prediction-coded stream 435 may be provided directly to the variable length encoder 444 for compression according to format B entropy compression techniques.

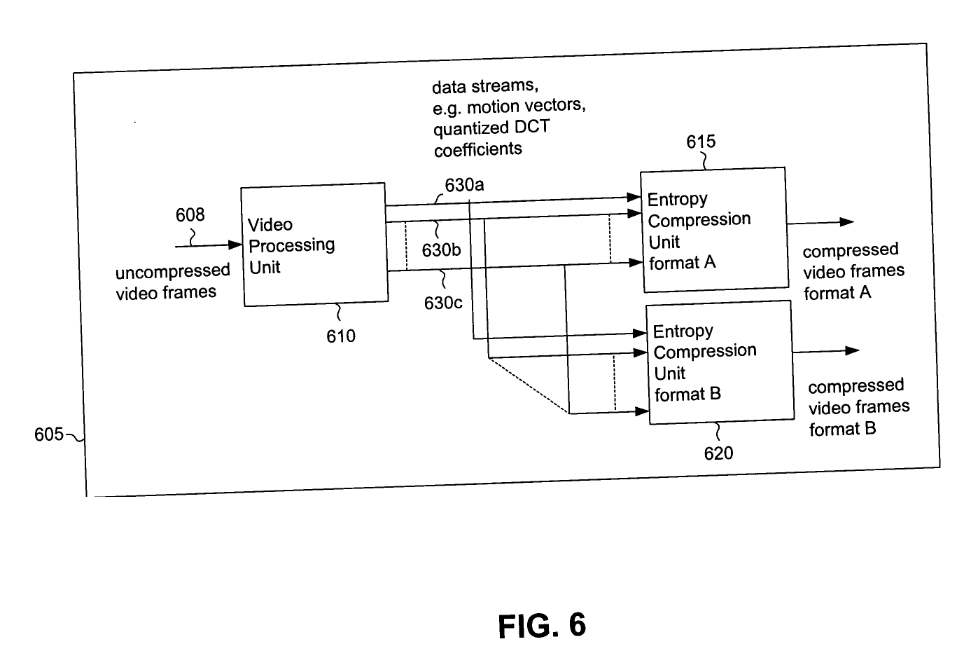

Referring now to FIG. 6, a block diagram is provided of a dual output encoder 605 operative to generate compressed video output in either a format A, a format B, or in both formats simultaneously. As shown, dual output encoder 605 includes a video processing unit 610 configured to receive uncompressed video data 608 and generate intermediate data streams 630_{a-c}, which are received by both a first entropy compression unit 615 operative in accordance with format A and a second entropy compression unit 620 configured to produce compressed output consistent with format B. Again, the format B compression utilizes compression techniques (e.g., arithmetic coding) that provide increased compression relative to format A compression techniques (e.g., Huffman coding). In one embodiment, format B provides such increased compression without losing data.

In the embodiment of FIG. 6, the two entropy compression units 615, 620 are configured to process the same syntactic elements provided by the video processing unit 610. As a consequence, the dual output encoder 605 only requires a single video processing unit 610. Thus, the dual output encoder 605 of the present embodiment requires fewer resources (e.g. system memory, program size, silicon area, electrical power) than would be required if a separate video processing unit were implemented for each compression unit 615, 620.

In an exemplary embodiment, the format B entropy compression unit 620 compresses one or more of the intermediate streams 630_{a-c}, which the format A entropy compression unit 615 does not compress. In these embodiments, the compression gains provided by the format B entropy compression unit 620 include gains due to improved compression techniques (e.g., arithmetic compression techniques) and gains due to compressing streams, which are not compressed at all.

In one embodiment for example, the video processing unit 610 processes the uncompressed video stream 608 according to the ISO/IEC 144496-2 specification to produce intermediate streams 630_{a-c}, which include a “not_coded” syntactic element. This element is compressed by the format B entropy compression unit 620, but is not compressed by the format A compression unit 615.

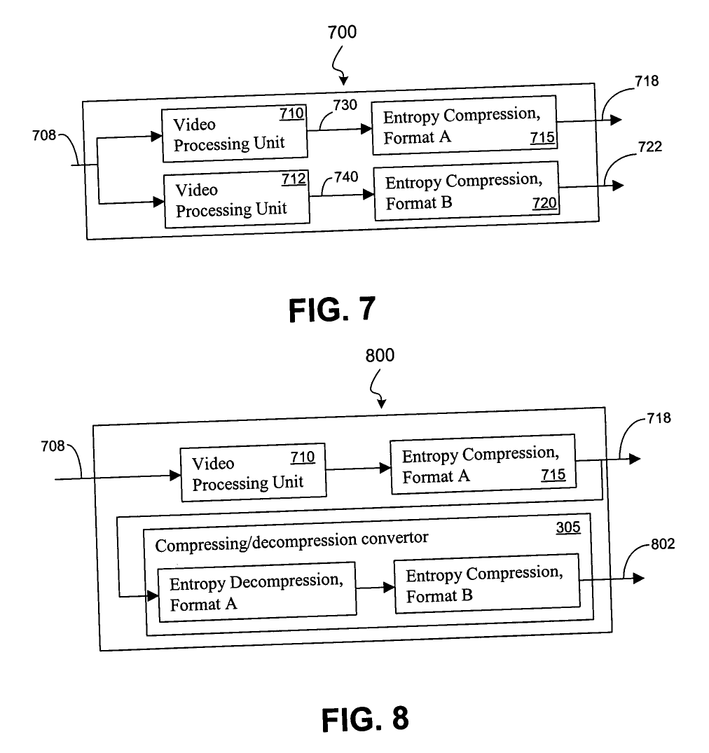

Referring next to FIG. 7, shown is a block diagram depicting a dual output encoder 700 according to an alternative embodiment of the present invention. As shown, the dual output encoder 700 includes a first video processing unit 710, which receives an uncompressed data stream 708 and provides intermediate data streams 730 to a format A entropy compression unit 715, which generates a format A compressed stream 718 by compressing one or more of the intermediate data streams 730 according to format A compression techniques. The dual output encoder 700 also includes a second video processing unit 712 which receives an uncompressed data stream 708 and provides intermediate data streams 740 to a format B entropy compression unit 720, which generates a format B compressed stream 722 by compressing one or more of the intermediate data streams 740 according to format B compression techniques.

In an exemplary embodiment, the format B compression unit 720 uses improved compression techniques (e.g., arithmetic coding) relative to those used by the format A compression unit 715 (e.g., Huffman coding) to generate the format B compressed stream 722 without a loss of image data.

In several embodiments, the first and second video processing units 710, 712 are configured to generate identical intermediate streams 730, 740, which are compressed according to different compression techniques. In some of these embodiments, however, the format B entropy compression unit 720 compresses some syntactic elements of the intermediate data streams 730, 740, which the format A compression unit 715 does not compress.

Referring next to FIG. 8, shown is a block diagram of yet another embodiment of a dual output encoder 800. As shown, the uncompressed stream 708 is converted into a format A compressed stream 718 by the video processing unit 710 and the format A entropy compression unit 715 in the same manner as described with reference to FIG. 7. In this embodiment, however, the format A compressed stream 718 is received by the compressing converter 305 which generates a format B compressed stream 802 as described with reference to FIG. 3.

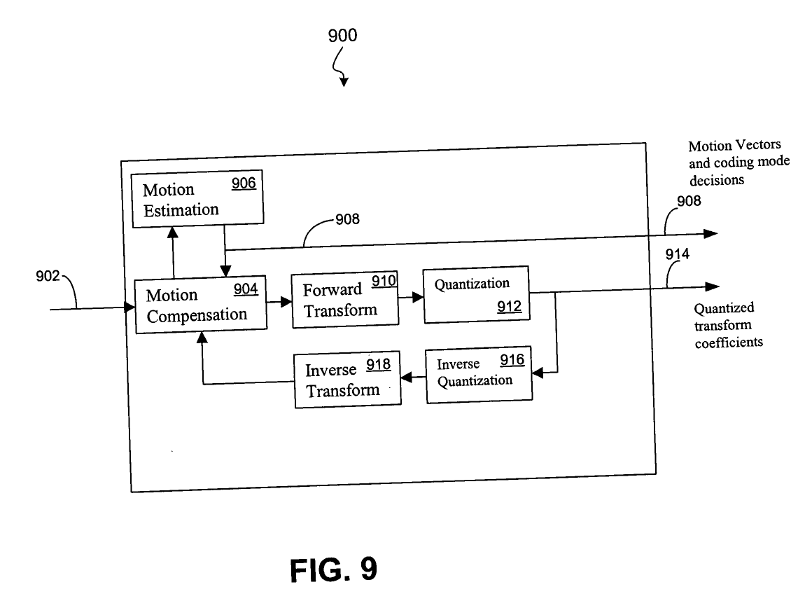

Referring next to FIG. 9, shown is a block diagram depicting one embodiment of a video processing unit 900 capable of implementing the video processing unit 610 of FIG. 6 and the video processing units 710, 712 of FIG. 7. As shown, a motion compensation module 904 within the video processing unit 900 receives an uncompressed video stream 902 and processes each frame within that stream. Each frame is passed to the motion estimation unit 906 together with zero or more reference frames that were previously stored by the motion compensation unit 904. The motion estimation unit 906 performs a searching algorithm to discover good motion vectors and mode decisions for subsequent use by the motion compensation module 904. These motion vectors and coding mode decisions 908 are output from the video processing unit 900. The motion compensation unit 904 generates a compensated frame using reference frames, motion vectors and mode decisions and subtracts this compensated frame from the uncompressed input frame to yield a difference frame. The forward transform unit 910 receives the difference frame and performs a forward spatial transform, such as block-DCT. The quantization unit 912 quantizes the transform coefficients produced by the forward transform in order to reduce their entropy and in doing so may lose some information. The quantized transform coefficients 914 are output from the video processing unit 900. The inverse quantization 916 and inverse transform 918 units replicate the reconstruction process of a video decoder and produce a reference frame that is delivered to the motion compensation unit 904 for optional future use.

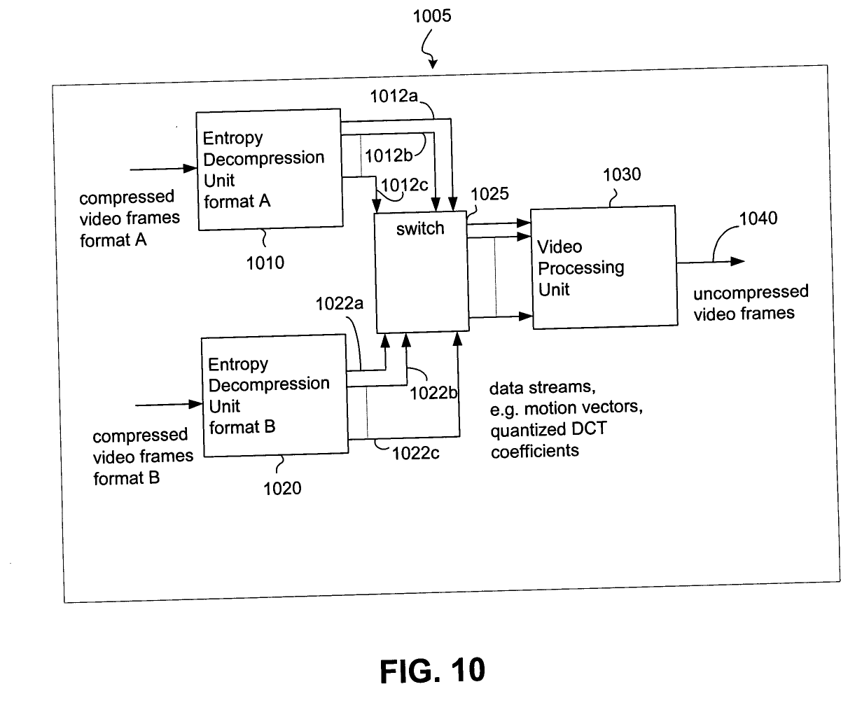

Referring next to FIG. 10, shown is a block diagram of a dual input decoder 1005 capable of decoding video information compressed in either format B or format A. As shown, dual input decoder 1005 includes a first entropy decompression unit 1010 operative to generate decompressed intermediate video streams 1012_{a-c}, which are provided to a switch 1025. Dual input decoder 1005 also includes a second entropy decompression unit 1020 configured to produce decompressed intermediate streams 1022_{a-c}, which are also provided to the switch 1025. The switch 1025 selects and relays either intermediate streams 1012_{a-c} from the first decompression unit 510 or intermediate streams 1022_{a-c} from the second decompression unit 1020 to the video processing unit 1030 in accordance with the format being decoded. The video processing unit 1030 then processes the intermediate streams 1012_{a-c}, 1022_{a-c} according to well known processing techniques so as to generate an uncompressed video stream 1040. The dual input decoder 1005 requires fewer resources (e.g. system memory, program size, silicon area, electrical power) than other potential decoding solutions, including, for example, a decoder for format A and separate decoder for format B, a decoder for format A only and a decompressing converter, and a decoder for format B only and compressing converter.

Arithmetic Coding

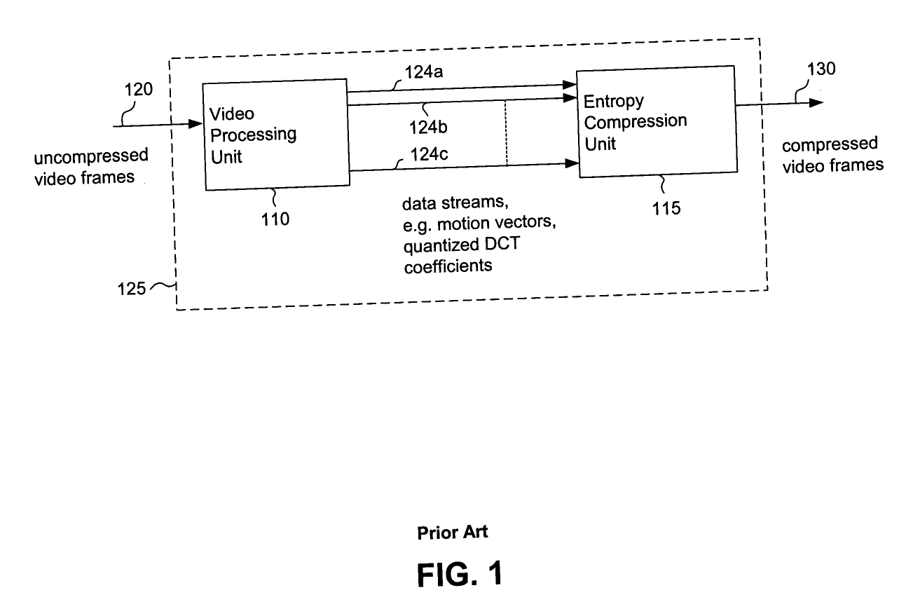

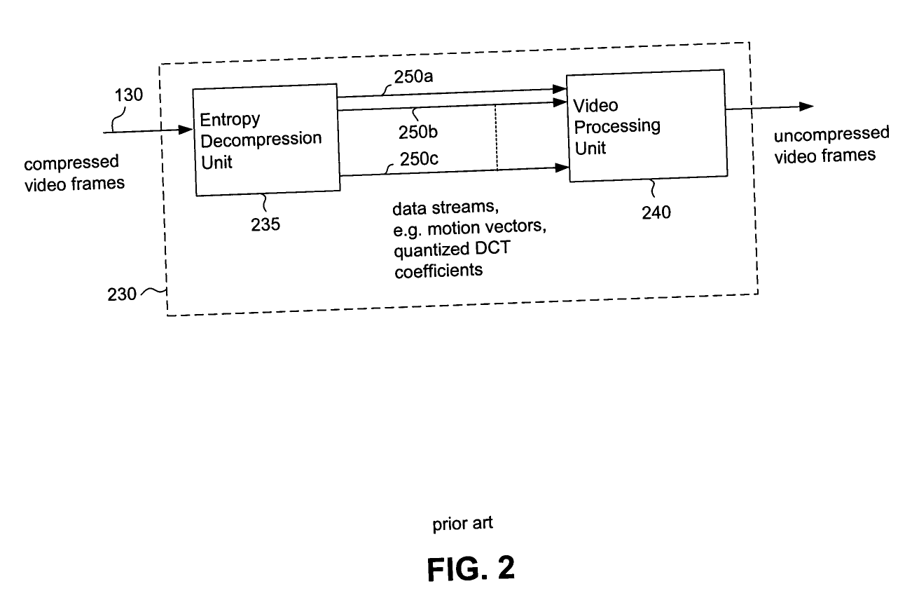

In some of the embodiments described with reference to FIGS. 1-10, inventive arithmetic compression techniques are utilized to effect the format B compression. The arithmetic coding techniques according to an exemplary embodiment of the present invention involve the use of arithmetic coding to compress two-dimensional bitmaps (1-bit planes) of compressed content. During the encoding process, a Context parameter is calculated with respect to each bit position based upon the neighboring bitmap values surrounding such position. In an exemplary embodiment, the Context parameter may assume values from 0 to 16, inclusively, each of which is indicative of a different composition of such neighboring bitmap values.

For example, a Context value of “16” corresponds to the case in which all neighboring bitmap values are “1”, which is usually very unlikely to occur. Each Context value is used as an index into an array of predetermined probability tables utilized in an arithmetic encoding process described hereinafter. The result of this arithmetic encoding process is then incorporated within the stream of compressed digital content, which is then transmitted to a decoder as an arithmetically compressed stream (e.g., as compressed stream 330, 722, 802) also referred to herein as a “supercompressed stream.”

At the decoder, the received stream of supercompressed digital content is subjected to an arithmetic decompression process. For each bitmap position, the same Context value used during the encoding process is re-computed based upon previously decoded neighboring bitmap values. The re-computed Context value is used as an index into an array of predetermined probability tables that is identical to the array used during the encoding process.

The retrieved information is then used to recover the original compressed digital content (e.g., MPEG-4 video) from the received stream of supercompressed digital content.

As shown in FIG. 11, four different cases exist with respect to which the Context of bits may be calculated (when scanning from left-to-right and top-bottom). For the bits completely inside the bitmap (shown in FIG. 11(a)), Context can be calculated as:

Context=1+A+2*B+4*C+8*D

For the bits on the left edge of the bitmap (shown in FIG. 11(b)), Context can be calculated as:

Context=1+5*A+10*B

For the bits on the top edge of the bitmap (shown in FIG. 11(c)), Context can be calculated as:

Context=1+10*A+5*B

(excluding two left top bits, which will be coded using Context=0).

Finally, for bits on the right edge of the bitmap (shown in FIG. 11(d)), Context an be calculated as:

Context=1+A+10*B+4*C

Entropy Compression for a 2D Array of Events

In an exemplary embodiment, the generic compression scheme described above can be applied to two-dimensional video frame information contained in an event matrix. The event matrix can have n entries, each of which corresponds to a rectangular block of the video frame. The blocks are not constrained to be all the same shape or size, and there may be gaps between blocks in the array where a decoder knows by other means that no event information is expected.

The statistical characteristics of the event matrix are then analyzed in order to facilitate generation of probability table arrays. When encoding an event, the probability table is selected in accordance with the Context value at the array location corresponding to such event. In certain implementations it is possible that more than a single hard-coded probability table array may exist for the same data. In such cases, the data is analyzed prior to encoding in order to enable appropriate selection of one of the probability table arrays.

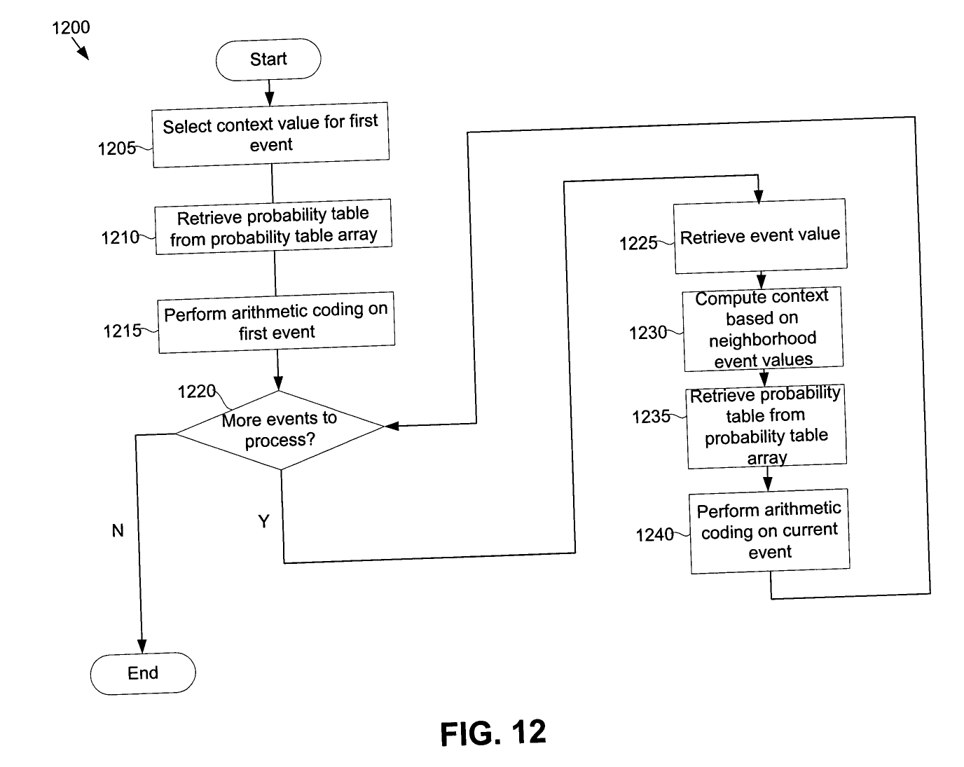

Referring next to FIG. 12, shown is a flowchart illustrating steps carried out during an exemplary implementation of the inventive arithmetic coding process. The steps set forth in FIG. 12 are carried out by a variable length-encoding module (e.g., variable length encoding module 444, 446, 448) of an entropy compression unit (e.g., entropy compression unit 315, 415, 620, 720). The variable length-encoding module (e.g., variable length encoding module 444, 446, 448) performs a raster iteration over the all n events in the event matrix, performing the steps shown in FIG. 12 for each event eᵢ (i=1 to n).

As shown in FIG. 12, at a step 1205 a “special” Context value is generally selected and used for the first two elements in the event matrix (which are handled separately, since in the exemplary implementation at least two known values are needed to compute Context). At a step 1210, the Context value is used as an index into the array of predetermined probability tables, and the probability table is retrieved. Each entry in the array is a table whose entries provide the probabilities of occurrence of all possible values of event eᵢ. At a step 1215, arithmetic coding is performed on the first event using the event's value and the probability table. It is observed that the first and second events are typically processed in the same way as all other events, with the exception that the Context values for the these events are set to a predefined value used only in connection with these events.

At a step 1220, a determination is made of whether any further events from the event matrix are to be processed. If so, control passes to a step 1225, in which the next element (i.e., event) is retrieved from the event matrix. In a step 1230, a Context value is computed from a function of values of previously processed neighborhood events. At a step 1235, the Context value is used as an index into the array of predetermined probability tables. Each entry in the array is a table whose entries provide the probabilities of occurrence of all possible values of event eᵢ. At a step 1240, arithmetic coding is performed using the probability table and the event's value.

As the events of the matrix are processed in this way, the resulting output from the a variable length encoding module (e.g., variable length encoding module 444, 446, 448) is incorporated into the compressed data stream (e.g., by the format B multiplexer 450) for the present video frame in order to thereby generate a supercompressed data stream (e.g., format B compressed stream 330).

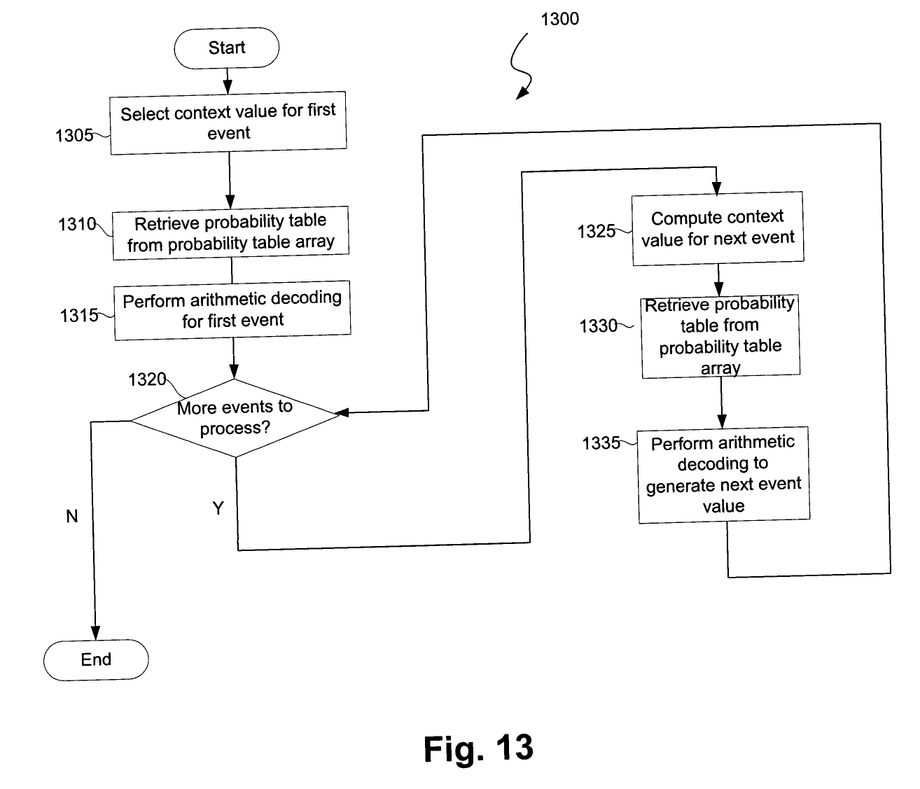

For decoding of the supercompressed stream, the same compressed data stream inherent therein is input into an arithmetic coding entropy decompression unit (e.g., the format B entropy decompression unit 520). The arithmetic coding entropy decompression iterates over a decoded event matrix using the same raster as the variable length encoder (e.g., the variable length encoder 444, 446, 448). At each event position, the arithmetic coding entropy decompression unit (e.g., the format B entropy decompression unit 520) performs the following steps, as detailed in FIG. 13, to produce decoded events eᵢ that are identical to the encoded events eᵢ (for i=1 to n).

At a step 1305, a predefined Context value is selected for the first and second elements in the event matrix (which, as in the encoding case, are handled separately from other events). At a step 1310, a probability is selected for the first element in the event matrix. With the Context value and the probability value, arithmetic decoding is performed in a step 1315, using a standard arithmetic decoding process.

At a step 1320, a determination is made of whether any further events for the event matrix are to be reconstructed (i.e., decoded). If so, control passes to a step 1325, in which the Context value for the next element (i.e., event) is computed from the existing event values in the event matrix being decoded. In a step 1330, the Context value is used as an index into an array of predetermined probability tables that are identical to the predetermined probability tables used in the encoding process. In a step 1335, the probability value retrieved in the preceding step is passed to the arithmetic decompression unit (e.g., the format B entropy decompression unit 1320), which uses this information together with the input compressed data stream to compute eᵢ.

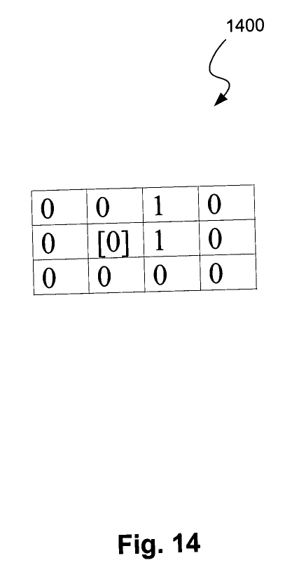

FIG. 14 shows an example of an event matrix 1400 that can be compressed using the inventive arithmetic coding method according to the present invention. In this example, event matrix 1400 represents the not_coded event matrix that is an array with dimensions one sixteenth of the video resolution. For video with resolution of 64×48 (width×height) then the not_coded layer or event matrix could take on the values shown in FIG. 1400.

The encoder iterates over this matrix as the values would be read (i.e., raster iteration or left-to-right and top-to-bottom). Upon reaching the value indicated with [ ] in FIG. 14, the Context value can be computed as:

c[x,y]=1+e[x−1y]+2*e[x−1y−1]+4*e[xy−1]+8*e[x+1y−1]=9

In this example, the Context value of 9 will result in statistics table #9 being selected. Statistics table #9 will most likely show that the probability of finding a 0 is high. The statistics information together with the value of interest (i.e., 0) from the event matrix is passed to an arithmetic coding module (e.g., arithmetic coding module 444, 446, 448) within an arithmetic coding entropy compression unit (e.g., entropy compression unit 315, 415, 620, 720).

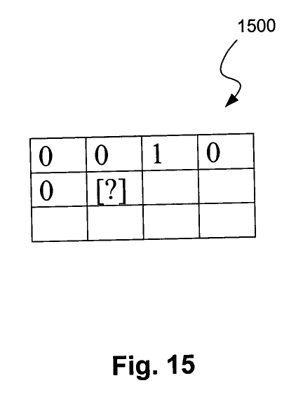

At the decoder, previous binary events in the raster iteration leading up to the same example bit above would have already been decoded. Thus, the currently decoded event matrix in this example might look like the one shown in FIG. 15, where [?] indicates the value that can be decoded next. As in the encoder, a Context value of 9 is computed. Accordingly, the exact same statistics table #8 that was used in the encoder can be retrieved. The information now available is enough for an arithmetic decompressor to output the value ‘0’.

In an exemplary embodiment, the compression scheme according to the present invention is applied to MPEG-4 p-frames, which contain up to 90-95% of all data in a digital video stream. Information in a p-frame can be structured into several planes (i.e., “event matrices”) with different levels of detail. These event matrices, in ISO/IEC 14496-2 specification terminology, are:

‘not_coded’—A basic event matrix. It is a two-dimensional bitmap with each bit indicating if any further data will be transmitted for a corresponding 16×16 ‘macroblock’. In MPEG-4 it is not compressed at all (exactly one bit is transmitted for each entry).

‘mcbpc’—This event matrix contains information on several aspects, including: (a) whether chrominance blocks in this macroblock are coded, (b) the encoding mode of this macroblock (e.g., inter or intra), (c) the number of motion vectors used, and (d) whether this macroblock is a quantizer change point. For compression purposes the mcbpc event matrix can be split into ‘intra’, ‘inter4v’, ‘cbpc’, and ‘inter_q’ layers.

‘cbpy’—This event matrix contains information on whether luminance blocks of this macroblock are coded.

‘motion_vector’—This event matrix contains information on motion vector or vectors associated with the macroblock.

‘acpred’, ‘dquant’, ‘mcsel’—This event matrix contains supporting information, and is not present in most macroblocks.

‘blocks’—This event matrix contains information on quantized DCT coefficients. This event matrix occupies the most space in P-frames at high bitrates, but is also the least compressible one. It can be also split into ‘dct’ and ‘block_sizes’ layers. Information from ‘block_sizes’ indicates how many codes are present in the certain block, and information from ‘dct’ tells what they actually are.

Block-Coded Matrix Approach to Arithmetic Coding

For each block in a matrix of blocks, an event eᵢ is a binary value whose meaning is:

eᵢ=0 indicates an image block at position i is skipped and the block at position i in the previously decoded video frame is to be output by the decoder instead.

eᵢ=1 indicates motion and/or texture information for this block are included in the compressed data stream for this video frame.

The preferred embodiment for a block-coded matrix compressor includes an analyzer that determines the level of correlation between neighboring blocks in the block-coded array. The output of this analyzer is used to select a probability table array that is suited to that particular block-coded event matrix.

The preferred embodiment for a block-coded matrix having blocks of equal size and event e_{xy} at row y, column x, uses a raster iterating along each row of the image in sequence. The four closest already-encoded events are used to compute a Context c_{xy} value in the range 0 to 16:

c_{xy}=1+e_{x-1y}+2*e_{x-1y-1}+4*e_{xy-1}+8*e_{x+1y-1}

CBPY/CBPC Arithmetic Coding Approach

Unlike in MPEG-4, coded block pattern luminance (CBPY) information will be stored before coded block pattern chrominance (CBPC) information. CBPY comprises an event which has 16 possible values, and which indicates whether luminance texture information is available for a given 8×8 block within a 16×16 macroblock. Similarly, CBPC is an event which contains approximately 22 possible values. The CBPC event indicates whether chrominance texture information exists for a current macroblock, and provides an indication of the type of such macroblock (i.e., the manner in which the macroblock is encoded).

As well as not_coded and intra information, CBPY information can be considered a 2_{d} bitmap. In addition, each frame is divided into a number of ‘subframes’, each side approximately 10-15 macroblocks long. For each subframe, one of 4 statistics tables is selected and its index is written into the bitstream. In one embodiment, at Step 1210 a probability table is selected from among sixteen probability tables and CBPC is compressed according to the selected probability table, which is selected by the value of CBPY of macroblock.

Intra-Coded Matrix Arithmetic Coding Approach

For each block in a matrix of blocks, event code eᵢ is a binary value whose meaning is:

eᵢ=0 indicates image block at position i is coded using inter-frame prediction.

eᵢ=1 indicates image block at position i is coded using intra-frame means.

Intra-coded matrices can be compressed using the general method described above, with the following modification. First, the number of intra-coded macroblocks in the frame is determined. It is very likely that there will be no intra-coded macroblocks at all, or only a few. Correspondingly, a 2-bit index can be calculated that describes density of intra-coded blocks and can take on the following values in an exemplary embodiment of the present invention:

00: indicates no intra-coded macroblocks

01: indicates less than 1 intra-coded macroblock per 100 total macroblocks

10: indicates less than 1 intra-coded macroblock per 10 total macroblocks

11: indicates more than 1 intra-coded macroblock per 10 total macroblocks

This index is written directly into the bitstream. If there are no intra-coded macroblocks, no further information needs to be written. Otherwise, arithmetic compression can be applied using one of 3 statistics tables, selected using the index. Macroblocks with not_coded bit=1 are skipped.

Encoding of inter4v may be performed using the same method and statistics tables as of intra-coded. Macroblocks, which are already known to be intra-coded, cannot be inter4v, so they are skipped.

The preferred embodiment for an intra-coded matrix compressor includes an analyzer that determines the proportion of events in the event matrix, or in a local area of the matrix, that have value 1. The output of this analyzer is used to select a probability table array that is suited to that particular intra-coded event matrix.

The preferred embodiment for an intra-coded matrix having blocks of equal size and event e_{xy} at row y, column x, uses a raster iterating along each row of the image in sequence. The four closest already-encoded events are used to compute a Context c_{xy} value in the range 0 to 16:

c_{xy}=e_{x-1y}+2*e_{x-1y-1}+4*e_{xy-1}+8*e_{x+1y-1}

Blocks known to be skipped can be omitted in the raster scan at both encoder and decoder.

Encoding of inter4v may be performed using the same method and statistics tables as of intra. macroblocks, which are already known to be intra (and cannot be inter4v), so they are skipped.

Motion-Compensation Mode Matrix Arithmetic Coding Approach

For each block i in a matrix of blocks, an event eᵢ is a vector describing a motion vector. The preferred embodiment selects a probability table based on the maximum motion vector magnitude for the video frame being coded. The magnitude of the motion vector component having greater magnitude is entropy coded using the selected probability table. If this motion vector component is not zero, its logarithm is used to select a second probability table. The magnitude of the remaining motion vector component is encoded using this second table.

The signs of any non-zero motion vector components are signaled in the compressed data stream using a single bit for each component. If either component is non-zero, a bit is written to the data stream to record which motion vector component had the larger magnitude.

The above process may be described in more detail as follows. Specifically, for each motion-compensation mode block in a matrix of blocks, event code eᵢ is a binary value whose meaning is:

eᵢ=0 indicates image block at position i is coded using one motion vector per block.

eᵢ=1 indicates image block at position i is coded using four motion vectors per block.

Compression of motion vectors may be extended to an n'ary value where there are n different motion compensation modes to be encoded.

In an embodiment, motion compensation vectors can be calculated by first comparing the absolute values of two components of motion vectors. The larger of the two is named ‘max_code’, and smaller of two is named ‘min_code’. In this embodiment, ‘max_code’ is written into the bitstream, using the statistics table, selected with fixed_code frame parameter (there are 8 possible values of fixed_code and, correspondingly, 8 different tables). In this exemplary embodiment, the fixed_code frame parameter is explicitly sent at the beginning of the bitstream (in both format A and format B).

If ‘max_code’ is 0, motion vector is null and no further data needs to be written. Otherwise, integer logarithm of ‘max_code’ (smallest integer N such as 2**N>=max_code) is calculated. It is used to select one of 8 statistics tables for ‘min_code’.

After both ‘max_code’ and ‘min_code’ are written, up to three bits may need to be written: a bit which shows whether x or y component is ‘max_code’ (if max_code !=min_code), the sign of x (if abs(x) !=0) and the sign of y (if abs(y) !=0).

Texture-Coded Matrix Arithmetic Coding Approach

For each block in a matrix of blocks, an event eᵢ is a binary value whose meaning is:

eᵢ=0 indicates no texture is coded for the image block at position i and only motion compensation information is used.

eᵢ=1 indicates texture information for this block is included in the compressed data stream for this video frame.

The preferred embodiment for coding of luminance texture-coded events divides the matrix of blocks into regions. The statistics of eᵢ for each region is analyzed in order to select a probability table array that is suited to that region.

The preferred embodiment for coding of chrominance texture-coded events generates a Context value based on the values of the collocated luminance texture-coded events. This Context value is used to select the optimum entry in a probability table array.

Arithmetic Coding Approach for Quantized Block Transform Coefficients

The preferred embodiment arranges coefficients into a string by ordering them along a predetermined path through the block coefficients (e.g. zig-zag scan). The string is truncated at the last non-zero coefficient in the string. The length of the string and its contents are encoded separately.

Quantized Coefficient String Length Arithmetic Coding Approach

The length of the coefficient string at block i forms an event eᵢ. A Context, cᵢ is computed based on the number of local blocks with no texture coding and on the distribution of the total number per block of non-zero quantized transform coefficients in the video frame being encoded. cᵢ forms the index into an array of probability tables. The returned probability table is passed together with event eᵢ to an arithmetic coding module (e.g., variable length encoding module 444, 446, 448) within an arithmetic coding entropy compression unit (e.g., entropy compression unit 315, 415, 620, 720).

Quantized Coefficient String Values Arithmetic Coding Approach

The coefficient string is converted into a string of events. Each event eᵢ in the string is derived by pairing a non-zero coefficient value with the number of immediately preceding consecutive zero coefficient values. For each event eᵢ a Context cᵢ is derived from one or more of:

the position in the coefficient string of the non-zero coefficient in eᵢ;

the total length of the coefficient string; and

the absolute level of the previous non-zero coefficient.

The Context is used as an index into an array of probability tables. The returned probability table is passed with eᵢ to an arithmetic coding module (e.g., variable length encoding module 444, 446, 448) within an arithmetic coding entropy compression unit (e.g., entropy compression unit 315, 415, 620, 720).

Set forth in detail above are aspects of at least one embodiment of the present invention. Each of the features set forth above may be implemented in one system, method, and/or computer executable code in accordance with an embodiment of the present invention. Alternatively, each of the features set forth above may be separately implemented in different systems, methods, and/or computer executable codes in accordance with embodiments of the present invention.

Furthermore, the principles, preferred embodiments, and modes of operation of the present invention have been described in the foregoing description. However, the invention that is intended to be protected is not to be construed as limited to the particular embodiments disclosed. Further, the embodiments described herein are to be regarded as illustrative rather than restrictive. Others may make variations and changes, and equivalents employed, without departing from the spirit of the present invention. Accordingly, it is expressly intended that all such variations, changes and equivalents which fall within the spirit and scope of the present invention as defined in the foregoing claims be embraced thereby.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for converting digital video from a first compressed format to a second compressed format, the method comprising:
receiving an input digital video stream in said first compressed format;
demultiplexing said input digital video stream so as to generate a multiplicity of constituent data streams, wherein said constituent data streams include a compressed data stream;
decompressing said compressed data stream so as to generate a decompressed data stream;
compressing said decompressed data stream so as to generate a recompressed data stream, wherein said recompressed data stream is more compressed than said compressed data stream and wherein said recompressed data stream conveys identical semantic information as said compressed data stream; and
multiplexing said recompressed data stream and a subset of said constituent data streams that was not subject to said decompressing into an output digital video stream in said second compressed format.

2. The method of claim 1, wherein said constituent data streams include an uncompressed data stream, wherein said compressing includes compressing said uncompressed data stream so as to generate a newly compressed data stream and wherein said multiplexing includes multiplexing said newly compressed data stream with said recompressed data stream and the subset of said constituent data streams that was not subject to said decompressing or said compressing.

3. The method of claim 2, wherein said compressing said uncompressed data stream includes compressing said uncompressed data stream according to arithmetic coding techniques so as to generate said newly compressed data stream as an arithmetically coded stream.

4. The method of claim 1, wherein said compressed data stream is Huffman coded and wherein compressing said decompressed data stream includes compressing said decompressed data stream according to entropy coding techniques.

5. The method of claim 4 wherein said compressing said decompressed data stream includes compressing said decompressed data according to arithmetic coding techniques.

6. The method of claim 1 wherein said input digital video stream comprises an MPEG-4 digital video stream.

7. The method of claim 1 wherein said first compressed format is an H.264 CAVLC compressed format and wherein said second compressed format is H.264 CABAC compressed format.

8. A method for converting digital video from a first compressed format to a second compressed format, the method comprising:
receiving an input digital video stream in said first compressed format;
demultiplexing said input digital video stream so as to generate a multiplicity of constituent data streams, wherein said constituent data streams include a compressed data stream;
decompressing said compressed data stream so as to generate a decompressed data stream;
compressing said decompressed data stream so as to generate a recompressed data stream, wherein said recompressed data stream conveys identical semantic information as said compressed data stream; and
multiplexing said recompressed data stream with a subset of said constituent data streams that was not subject to said decompressing into an output digital video stream in said second compressed format.

9. The method of claim 8 wherein said compressing includes compressing said decompressed data stream according to Huffman coding techniques so as to generate said recompressed data stream as a Huffman coded stream, and wherein said compressed data stream is an arithmetic coded data stream.

10. The method of claim 8 wherein said constituent data streams include another compressed data stream and wherein said decompressing includes decompressing said other compressed data stream so as to generate an uncompressed data stream; said multiplexing including multiplexing said uncompressed data stream with said recompressed data stream and said constituent data streams that was not subject to said decompressing.

11. The method of claim 8 wherein said compressed data stream is an arithmetic coded data stream and wherein said decompressing includes decompressing said compressed data stream according to arithmetic coding techniques.

12. The method of claim 10 wherein said compressed data stream is an arithmetic coded data stream and wherein said decompressing includes decompressing said compressed data stream according to arithmetic coding techniques.

13. A processor readable medium containing processor executable instructions for:
receiving an input digital video stream in a first compressed format;
demultiplexing said input digital video stream so as to generate a multiplicity of constituent data streams, wherein said constituent data streams include a compressed data stream;
decompressing said compressed data stream so as to generate a decompressed data stream;
compressing said decompressed data stream so as to generate a recompressed data stream, wherein said recompressed data stream is more compressed than said compressed data stream and wherein said recompressed data stream conveys identical semantic information as said compressed data stream; and
multiplexing said recompressed data stream and a subset of said constituent data streams that was not subject to said decompressing into an output digital video stream in a second compressed format.

14. The processor readable medium of claim 13, wherein said constituent data streams include an uncompressed data stream, wherein said compressing includes compressing said uncompressed data stream so as to generate a newly compressed data stream, wherein said multiplexing includes multiplexing said newly compressed data stream with said recompressed data stream and the subset of said constituent data streams that was not subject to said decompressing or said compressing.

15. The processor readable medium of claim 14, wherein said compressing said uncompressed data stream includes compressing said uncompressed data stream according to arithmetic coding techniques so as to generate said newly compressed data stream as an arithmetically coded stream.

16. The processor readable medium of claim 13 wherein said compressed data stream is Huffman coded and wherein compressing said decompressed data stream includes compressing said decompressed data stream according to entropy coding techniques.

17. The processor readable medium of claim 16 wherein said compressing said decompressed data includes compressing said decompressed data according to arithmetic coding techniques.

18. The processor readable medium of claim 13, wherein said input digital video stream comprises an MPEG-4 digital video stream.

19. The processor readable medium of claim 13, wherein said first compressed format is an H.264 CAVLC compressed format and wherein said second compressed format is H.264 CABAC compressed format.

20. A processor readable medium containing processor executable instructions for:
receiving an input digital video stream in a first compressed format;
demultiplexing said input digital video stream so as to generate a multiplicity of constituent data streams, wherein said constituent data streams include a compressed data stream;
decompressing said compressed data stream so as to generate a decompressed data stream;
compressing said decompressed data stream so as to generate a recompressed data stream, wherein said recompressed data stream conveys identical semantic information as said compressed data stream; and
multiplexing said recompressed data stream with a subset of said constituent data streams that was not subject to said decompressing into an output digital video stream in a second compressed format.

21. The processor readable medium of claim 20 wherein said compressing includes compressing said decompressed data stream according to Huffman coding techniques so as to generate said recompressed data stream as a Huffman coded stream, and wherein said compressed data stream is an arithmetic coded data stream.

22. The processor readable medium of claim 20 wherein said constituent data streams include another compressed data stream and wherein said decompressing includes decompressing said other compressed data stream so as to generate an uncompressed data stream; said multiplexing including multiplexing said uncompressed data stream with said recompressed data stream and the subset of said constituent data streams that was not subject to said decompressing.

23. The processor readable medium of claim 20 wherein said compressed data stream is an arithmetic coded data stream and wherein said decompressing includes decompressing said uncompressed data stream according to arithmetic coding.

24. The processor readable medium of claim 22 wherein said compressed data stream is an arithmetic coded data stream and wherein said decompressing includes decompressing said compressed data stream according to arithmetic coding.

25. A method for transforming uncompressed video frames into at least two compressed formats, the method comprising:
receiving uncompressed video frames;
processing said uncompressed video frames into intermediate data streams;
applying a first entropy compression format to at least some of said intermediate data streams so as to generate a first set of compressed data streams;
applying a second entropy compression format to at least some of said intermediate data streams so as to generate a second set of compressed data streams;
multiplexing at least said first set of compressed data streams so as to generate a video stream in accordance with said first format; and
multiplexing at least said second set of compressed data streams so as to generate a video stream in accordance with said second format.

26. A processor readable medium containing processor executable instructions for:
receiving uncompressed video frames;
processing said uncompressed video frames into intermediate data streams;
applying a first entropy compression format to at least some of said intermediate data streams so as to generate a first set of compressed data streams;
applying a second entropy compression format to at least some of said intermediate data streams so as to generate a second set of compressed data streams;
multiplexing at least said first set of compressed data streams so as to generate a video stream in accordance with said first format; and
multiplexing at least said second set of compressed data streams so as to generate a video stream in accordance with said second format.

27. A method for converting digital video from a first compressed format to a second compressed format, the method comprising:
receiving an input digital video stream in said first compressed format;
demultiplexing said input digital video stream so as to generate one or more compressed data streams and an uncompressed data stream;
decompressing one of said one or more compressed data streams so as to generate a decompressed data stream;
compressing said decompressed data stream so as to generate a recompressed data stream;
compressing said uncompressed data stream so as to generate a newly compressed data stream; and
multiplexing said recompressed data stream and said newly compressed data stream into an output digital video stream in said second compressed format.

28. The method of claim 27, wherein said multiplexing includes multiplexing another of said one or more compressed data streams with said recompressed data stream and said newly compressed data stream.

29. A method for converting digital video from a first compressed format to a second compressed format, the method comprising:
receiving an input digital video stream in said first compressed format;
demultiplexing said input digital video stream so as to generate a plurality of compressed data streams;
decompressing one of said plurality of compressed data streams so as to generate a decompressed data stream;
compressing said decompressed data stream so as to generate a recompressed data stream, wherein said recompressed data stream is more compressed than said one of said plurality of compressed data streams; and
multiplexing said recompressed data stream with another of said plurality of compressed data streams into an output digital video stream in said second compressed format.

30. The method of claim 29 wherein said compressing introduces losses that mean semantic information conveyed by said recompressed data stream is not identical to the semantic information conveyed by said one of said plurality of compressed data streams.

31. The method of claim 29 wherein said recompressed data stream conveys identical semantic information as said compressed data stream.
